(19) United States
(12) Patent Application Publication
(10) Pub. No.: US 2013/0109201 A1
(43) Pub. Date: May 2, 2013

(54) ELECTRICAL POWER CONNECTOR

(71) Applicants: Kun-Shen Wu, Taoyuan County (TW); Hao-Jan Tuan, Taoyuan County (TW)

(72) Inventors: Kun-Shen Wu, Taoyuan County (TW); Hao-Jan Tuan, Taoyuan County (TW)

(21) Appl. No.: 13/568,899

(22) Filed: Aug. 7, 2012

(30) Foreign Application Priority Data
Oct. 28, 2011 (TW) 100220373

(51) Int. Cl. H01R 12/72

(52) U.S. Cl. 439/59

(57) ABSTRACT

An electrical power connector includes an electrically insulative housing defining multiple front mating portions, a mating chamber in each mating portion for receiving one respective connection portion of a mating circuit board and two guide grooves in the mating chamber for guiding the respective connection portion of the mating circuit board into position, and pairs of conducting terminals respectively mounted in the mating chambers of the electrically insulative housing. Subject to the guiding of the guide grooves, the connection portions of the mating circuit board are kept in positive contact with respective front mating end portions of the conducting terminals to let the conducting terminals bear pressure evenly so that the operating conducting terminal impedance and temperature can be minimized, improving the reproducibility and reliability of the connector at the end of the circuit board and assuring a high level of power or signal transmission efficiency and safety.

This application claims the priority benefit of Taiwan patent application number 100220373, filed on Oct. 28, 2011.

### BACKGROUND OF THE INVENTION

1. Field of the Invention

The present invention relates to electrical connector technology and more particularly, to an electrical power connector, which effectively reduces the operating conducting terminal impedance and temperature.

2. Description of the Related Art

When designing an electrical connector, a designer normally will pay attention to two basic parts, i.e., signal and power supply. When designing a signal circuit, a designer normally will not consider the factor of current variation for the reason that the applied current is normally low. However, with respect to the transmission of signals, a designer may consider the nature of the carrier (high frequency, low frequency) and many other factors (static interference, magnetic interference, impedance matching, etc.) without taking the factor of temperature into account. With respect to power supply, conducting a high-current power supply through a power circuit will increase the impedance, causing a rise in temperature. Thus, when designing an electrical power connector, the factors of quick heat dissipation and low conducting terminal impedance must be considered, avoiding a significant change in the electrical characteristics.

Further, an electrical power connector may be adapted for conducting power supply in a power adapter or server and connected to gold fingers of a circuit board. However, any geometric deformation or centerline displacement of the circuit board may cause the springy metal terminals of the electrical power connector to bear uneven pressure, resulting in unbalanced contact stress. Any unbalanced contact stress may cause a change in impedance and contact surface area between the springy metal terminals of the electrical power connector and the gold fingers of the circuit board, affecting system performance and reliability. A small power loss of each of a large number of electrical power connectors in a computer room leads to a large amount of power loss and an increase in total variable cost.

Therefore, it is desirable to provide an electrical power connector, which eliminates the drawbacks of the prior art design.

### SUMMARY OF THE INVENTION

The present invention has been accomplished under the circumstances in view. It is therefore the main object of the present invention to provide an electrical power connector, which effectively reduces the operating conducting terminal impedance and temperature, improving the reproducibility and reliability of the connector at the end of the circuit board and assuring a high level of power or signal transmission efficiency and safety. It is another object of the present invention to provide an electrical power connector, which enhances air circulation and heat dissipation.

To achieve these and other objects of the present invention, an electrical power connector is electrically connected to at least one connection portion of a mating circuit board, comprising an electrically insulative housing and a plurality of conducting terminals. The electrically insulative housing comprises at least one mating portion disposed at a front side thereof, a plurality of partition plates disposed at a rear side thereof, an accommodation chamber defined between each two adjacent partition plates corresponding to one respective mating portion, a mating chamber defined in each mating portion, and two guide grooves bilaterally disposed in each mating chamber for guiding one respective connection portion of the mating circuit board into one respective mating chamber. The conducting terminals are arranged in pairs and respectively mounted in each accommodation chamber of the electrically insulative housing. Each conducting terminal comprises a panel base, a front mating end portion forwardly extended from the panel base and suspending in the front opening of one respective mating chamber, and a rear bonding end portion backwardly downwardly extended from the panel base. Subject to the guiding of the guide grooves, the connection portions of the mating circuit board are kept in positive contact with respective front mating end portions of the conducting terminals to let the conducting terminals bear pressure evenly so that the operating conducting terminal impedance and temperature can be minimized, improving the reproducibility and reliability of the connector at the end of the circuit board and assuring a high level of power or signal transmission efficiency and safety.

Further, during transmission of a high current through the electrical power connector and the connected mating circuit board, heat generated by the conducting terminals can be dissipated into the atmosphere through the gaps between the vertically arranged conducting terminals in each accommodation chamber, avoiding heat accumulation. Further, the mating circuit board has a simple structure suitable for mass production to reduce the cost.

### BRIEF DESCRIPTION OF THE DRAWINGS

FIG. 1 is an elevational view of an electrical power connector in accordance with the present invention.

FIG. 2 is an exploded view of the electrical power connector in accordance with the present invention.

FIG. 3 corresponds to FIG. 2 when viewed from another angle.

FIG. 4 is a schematic sectional elevation illustrating the relationship between the electrical power connector and the mating circuit board before installation according to the present invention.

FIG. 5 is a schematic sectional view illustrating the electrical power connector and the mating circuit board mounted together according to the present invention.

FIG. 6 is another schematic sectional elevation of the present invention before connection between the electrical power connector and the mating circuit board.

FIG. 7 is another schematic sectional view illustrating the electrical power connector and the mating circuit board mounted together according to the present invention.

### DETAILED DESCRIPTION OF THE PREFERRED EMBODIMENT

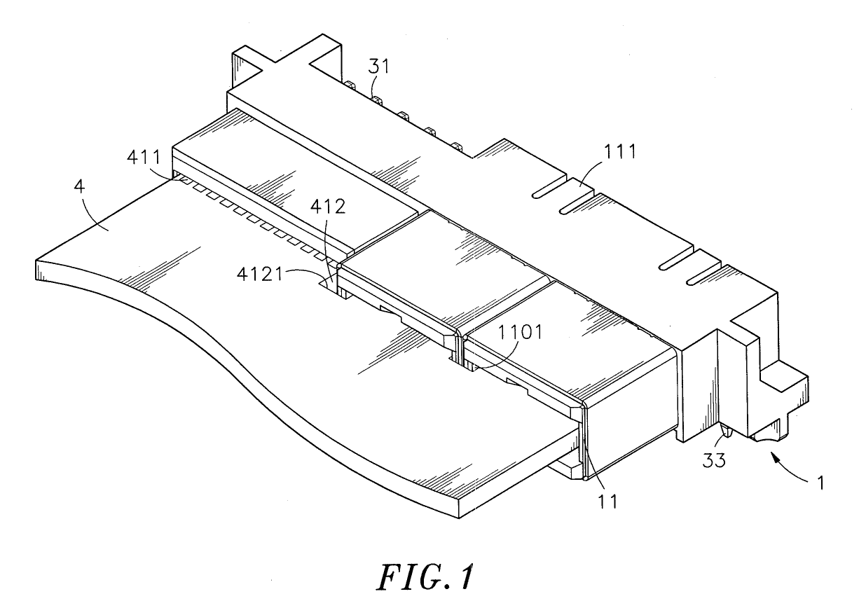

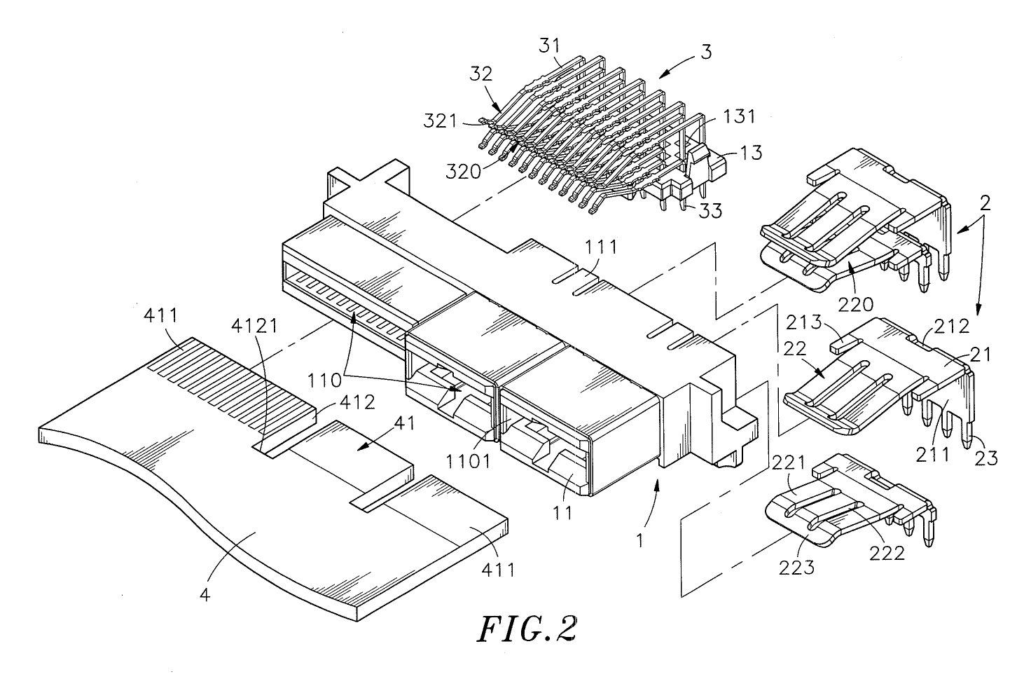

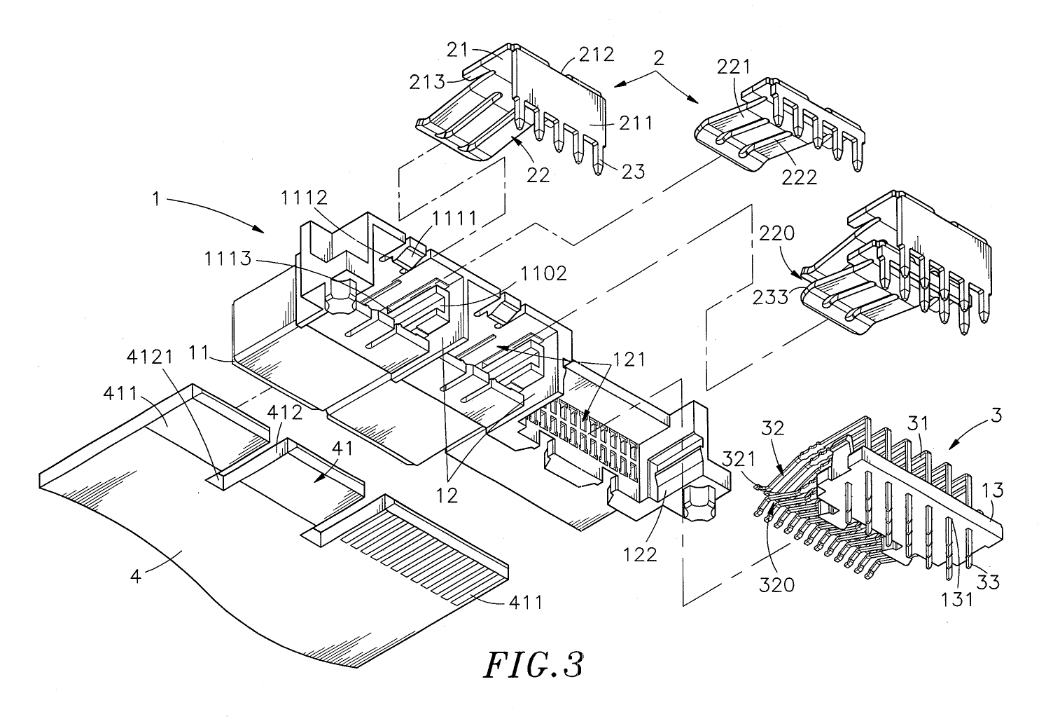

Referring to FIGS. 1, 2 and 3, an electrical power connector in accordance with the present invention is shown. The electrical power connector comprises an electrically insulative housing 1, and a plurality of conducting terminals 2.

The electrically insulative housing 1 comprises a plurality of mating portions 11 arranged in parallel at a front side thereof, a plurality of partition plates 12 disposed at a rear side thereof, an accommodation chamber 121 defined between each two adjacent partition plates 12 corresponding to one respective mating portion 11, a mating chamber 110 defined in each mating portion 11 and defining a front opening 1101 in communication with one respective accommodation chamber 121, two guide grooves 1102 bilaterally disposed in each mating chamber 110 between the associating front opening 1101 and accommodation chamber 121, and a plurality of springy hooks 111 extended from opposing top and bottom sides thereof and respectively suspending in top and bottom sides in each accommodation chamber 121. Further, each springy hook 111 defines a bevel face 1111 located on a distal end thereof, a vertical stop edge 1112 disposed at a back side of the bevel face 1111, and a stepped rear stop portion 1113 disposed adjacent to the associating mating chamber 110.

The conducting terminals 2 are arranged in pairs and respectively mounted in the accommodation chambers 121 of the electrically insulative housing 1. Each of the two vertically arranged conducting terminals 2 in each accommodation chamber 121 comprises a panel base 21 having a vertically downwardly extending rear connection portion 211, an opening 212 cut through opposing top and bottom sides of the rear connection portion 211 of the panel base 21, a front mating end portion 22 forwardly extended from the panel base 21 and suspending in the front opening 1101 of the corresponding accommodation chamber 121, two stop rods 213 forwardly extended from the panel base 21 and suspending at two opposite lateral sides relative to the front mating end portion 22, and a rear bonding end portion 23 downwardly extended from the rear connection portion 211 of the panel base 21. Further, a retaining gap 220 is defined between the two vertically arranged conducting terminals 2 in each accommodation chamber 121 of the electrically insulative housing 1. Further, the front mating end portion 22 of each conducting terminal 2 defines a turning face 221, at least one, for example, two longitudinal slots 222 cut through opposing top and bottom sides of the turning face 221, and a front guide slope 223 obliquely downwardly (or obliquely upwardly) extended from the turning face 221.

When assembling the electrical power connector, insert the front mating end portions 22 of each pair of conducting terminals 2 into each respective accommodation chamber 121 between each two respective partition plates 12 of the electrically insulative housing 1 against the bevel faces 1111 of the respective two springy hooks 111. At this time, the respective springy hooks 111 are elastically deformed for allowing the front mating end portions 22 of the respective pair of conducting terminals 2 to pass. When the front mating end portions 22 of each pair of conducting terminals 2 are set in position in the accommodation chamber 121, the respective springy hooks 111 immediately return to their former shape to engage the vertical stop edges 1112 thereof into the openings 212 of the respective conducting terminals 2 and to abut the stepped rear stop portions 1113 thereof against the stop rods 213 of the respective conducting terminals 2, and therefore the respective conducting terminals 2 are locked to the electrically insulative housing 1 by the respective springy hooks 111.

According to this embodiment, the electrically insulative housing 1 comprises three mating portions 11, one configured subject to a first configuration design, and the other two configured subject to a second configuration design. The mating portion 11 configured subject to the first configuration design comprises a bottom opening 122 at the bottom side of the accommodation chamber 121, and a terminal block 13 mounted in the bottom opening 122. The terminal block 13 holds two vertically spaced sets of signal terminals 3. Each signal terminal 3 comprises a base portion 31, a front contact portion 32 forwardly extended from the base portion 31 and terminating in a spring arm 321 in the front opening 1101 of the respective accommodation chamber 121, and a rear bonding portion 33 backwardly extended from the base portion 31 and downwardly inserted through one respective terminal hole 131 of the terminal block 13. Further, a retaining gap 320 is defined between the front contact portions 32 of the two vertically spaced sets of signal terminals 3.

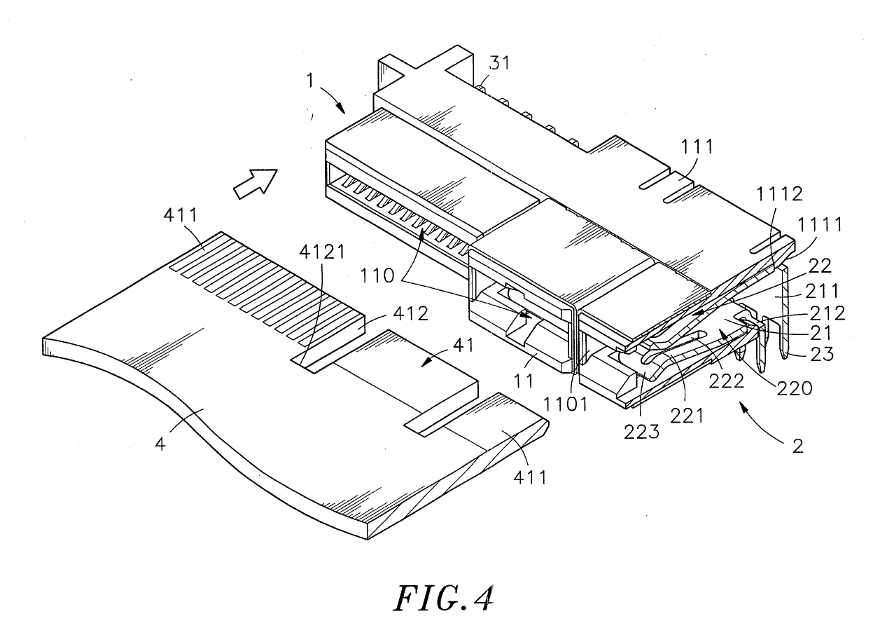

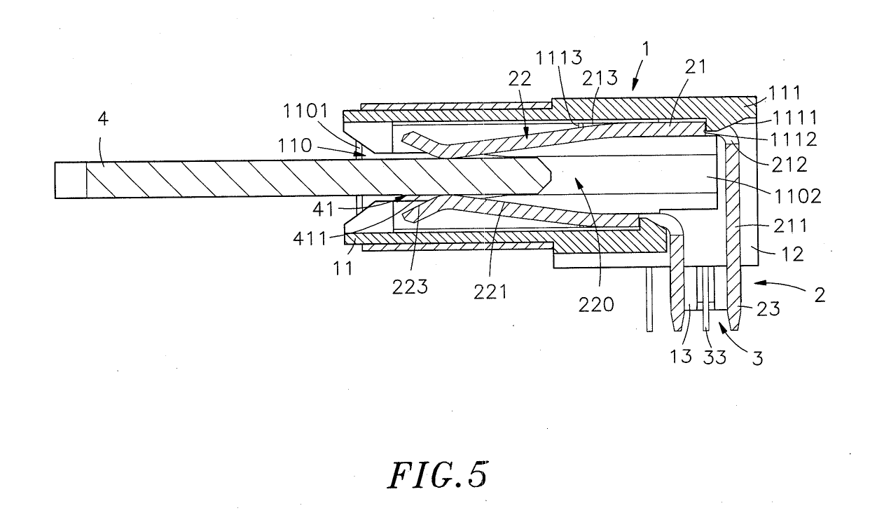

Referring to FIGS. 4 and 5, the electrical power connector is installed in a circuit board 4. The circuit board 4 comprises a plurality of connection portions 41 corresponding to the mating portions 11 of the electrical power connector, a front notch 412 defined between each two adjacent connection portions 41, a stop edge 4121 in each front notch 412, and a plurality of electric contacts 411 located on the opposing top and bottom sides of the connection portions 41.

During installation, the connection portions 41 of the circuit board 4 are respectively inserted through the front openings 1101 of the mating chambers 110 of the mating portions 11 of the electrically insulative housing 1 into the respective guide grooves 1102 in the respective mating chambers 110 and the retaining gaps 220 between the front mating end portions 22 of the respective vertically arranged conducting terminals 2 or the retaining gap 320 between the front contact portions 32 of the two vertically spaced sets of signal terminals 3. When set in position, the stop edges 4121 in the front notches 412 of the connection portions 41 of the circuit board 4 are respectively stopped against the front side of the mating portions 11 of the electrically insulative housing 1, and the turning faces 221 of the front mating end portions 22 of the conducting terminals 2 and the spring arm 321 of the front contact portions 32 of the signal terminals 3 of the terminal block 13 are respectively kept in contact with the respective electric contacts 411 at the connection portions 41 of the circuit board 4 positively. At this time, the thickness of the connection portions 41 of the circuit board 4 fits the height of the guide grooves 1102 so that the connection portions 41 of the circuit board 4 can be positively inserted into the respective guide grooves 1102 and guided by the respective guide grooves 1102 into position accurately and positively. Subject to the structural design of the guide grooves 1102, the front mating end portions 22 of the conducting terminals 2 bear the pressure evenly and are kept in positive contact with a wide surface area of the respective electric contacts 411 at the connection portions 41 of the circuit board 4 for the transmission of high currents, and therefore less impedance and temperature will be produced during transmission of high currents through the electrical power connector. Thus, a high level of reproducibility and reliability of the electrical power connector at the end of the circuit board can be obtained, assuring a high level of power transmission efficiency and safety. Further, the circuit board 4 has a simple structure suitable for mass production to reduce the cost.

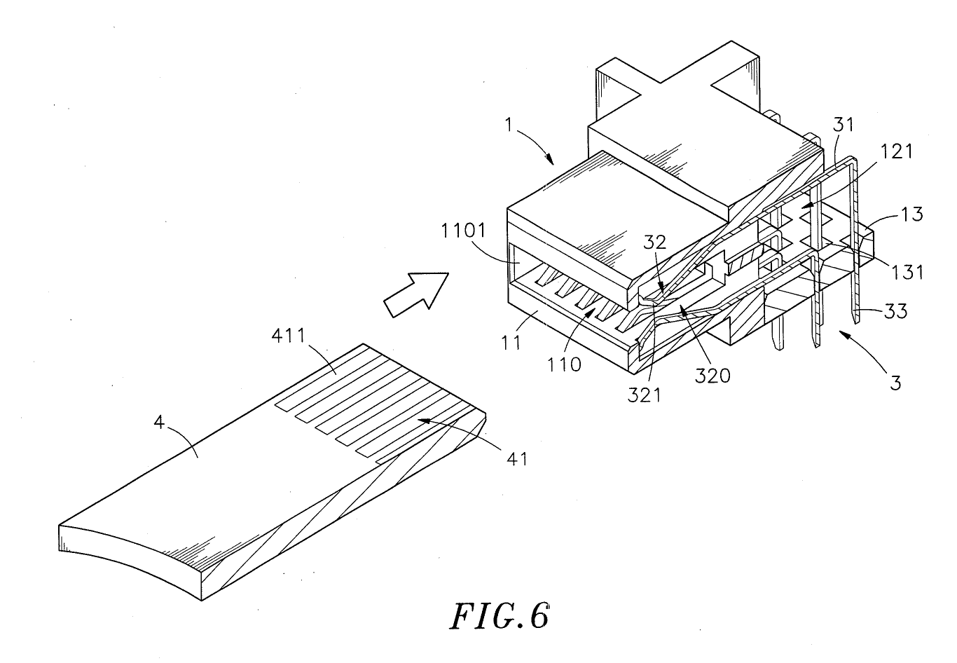

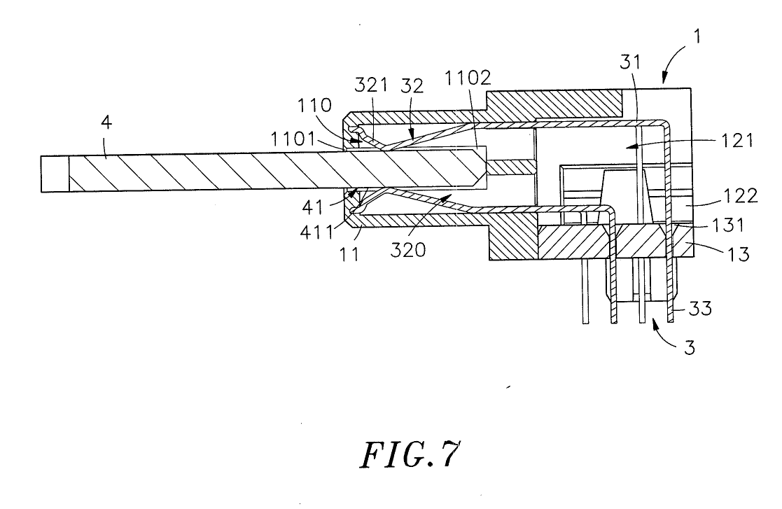

Referring to FIGS. 6 and 7, as stated above, the electrically insulative housing 1 comprises three mating portions 11, one configured subject to the first configuration design, and the other two configured subject to the second configuration design, wherein the mating portion 11 that is configured subject to the first configuration design is adapted for accommodating signal terminals 3, and the other two mating portions 11 that is configured subject to the second configuration design are adapted for accommodating the conducting terminals 2. Although the number and shape between the signal terminals 3 and the conducting terminals 2 are different, the mounting arrangement of the signal terminals 3 is substantially similar to that of the conducting terminals 2. Further, the design of the signal terminals 3 is not within the scope of the spirit of the present invention, no further detailed description is this regard is necessary.

During transmission of a high current through the electrical power connector and the connected circuit board 4, heat generated by the conducting terminals 2 can be dissipated into the atmosphere through the gaps between the vertically arranged conducting terminals 2 in the accommodation chambers 121. Further, the thickness of the circuit board 4 is much smaller than the height of the mating chambers 110 of the mating portions 11 of the electrically insulative housing 1. After insertion of respective connection portions 41 of the circuit board 4 into the mating chambers 110 of the mating portions 11 of the electrically insulative housing 1, currents of air caused by an electric fan can be guided through the mating chambers 110 of the mating portions 11 of the electrically insulative housing 1 to lower the temperature of the conducting terminals 2.

As stated above, the electrical power connector of the present invention is characterized in that the conducting terminals 2 are arranged in pairs and respectively mounted in the accommodation chambers 121 of the electrically insulative housing 1 between each two adjacent ones of the partition plates 12; two guide grooves 1102 are bilaterally disposed in each mating chamber 110 of the electrically insulative housing 1 between the associating front opening 1101 and accommodation chamber 121; the height of the guide grooves 1102 is determined subject to the thickness of the connection portions 41 of the mating circuit board 4 so that the connection portions 41 of the circuit board 4 can be positively inserted into the respective guide grooves 1102 and guided by the respective guide grooves 1102 into position accurately and positively.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electrical power connector electrically connected to at least one connection portion of a mating circuit board, comprising:
an electrically insulative housing comprising at least one mating portion at a front side thereof, a plurality of partition plates disposed at a rear side thereof, an accommodation chamber defined between each two adjacent said partition plates corresponding to one respective said mating portion, a mating chamber defined in each said mating portion, said mating chamber defining a front opening, and two guide grooves bilaterally disposed in each said mating chamber between the associating front opening and accommodation chamber for guiding one respective connection portion of said mating circuit board into one respective said mating chamber; and
a plurality of conducting terminals arranged in pairs and respectively mounted in said accommodation chambers of said electrically insulative housing, each said conducting terminal comprising a panel base, a front mating end portion forwardly extended from said panel base and suspending in the front opening of one said mating chamber, and a rear bonding end portion backwardly downwardly extended from said panel base.

2. The electrical power connector as claimed in claim 1, wherein said guide grooves in each said mating chamber have a height determined subject to the thickness of the at least one connection portion of said mating circuit board.

3. The electrical power connector as claimed in claim 1, wherein said at least one mating portion of said electrically insulative housing includes at least one first mating portion configured subject to a first configuration design and a second mating portion configured subject to a second configuration design, said first mating portion that is configured subject to said first configuration design comprising a bottom opening at a bottom side of the accommodation chamber thereof and a terminal block mounted in said bottom opening, said terminal block holding two vertically spaced sets of signal terminals, each said signal terminal comprising a base portion, a front contact portion forwardly extended from said base portion and suspending in the front opening of the respective accommodation chamber and a rear bonding portion backwardly extended from said base portion.

4. The electrical power connector as claimed in claim 3, wherein said terminal block comprises a plurality of terminal holes for the passing of the rear bonding portions of the respective signal terminals.

5. The electrical power connector as claimed in claim 3, wherein a retaining gap is defined between the front contact portions of the two vertically spaced sets of said signal terminals for retaining one respective connection portion of said mating circuit board.

6. The electrical power connector as claimed in claim 1, wherein the front mating end portion of each said conducting terminal defines a turning face, at least one longitudinal slot cut through opposing top and bottom sides of said turning face, and a front guide slope obliquely extended from said turning face.

7. The electrical power connector as claimed in claim 1, wherein a retaining gap is defined between the two vertically arranged conducting terminals in each said accommodation chamber of said electrically insulative housing for retaining one respective connection portion of said mating circuit board.

8. The electrical power connector as claimed in claim 1, wherein said mating circuit board comprises a plurality of connection portions respectively inserted into the mating chamber in each said mating portion of said electrical power connector, a front notch defined between each two adjacent said connection portions, and a stop edge defined in each said front notch and stopped against a front side of one respective said mating portion of said electrically insulative housing.
